(19) United States
(12) Patent Application Publication
(10) Pub. No.: US 2005/0082360 A1
(43) Pub. Date: Apr. 21, 2005

(54) Printed matter with multi-medium function and method of fabricating the same

(76) Inventor: Glen Shu, Sijhih City (TW)

Correspondence Address: Yi-Wen Tseng, 4331 Stevens Battle Lane, Fairfax, VA, 22033, US

(21) Appl. No.: 10/934,588

(22) Filed: Sep. 3, 2004

(30) Foreign Application Priority Data
Oct. 17, 2003 (TW) 092128951

(51) Int. Cl. G06F 17/00

(52) U.S. Cl. 235/375

(57) ABSTRACT

A printed matter has a plurality of texts and/or graphs and at least one identification code printed on a stationary medium. The identification code is used for identifying reference information of the texts and/or graphs. The printed matter further has a storage medium, an input device, a processor and an output device. The reference information is stored in the storage medium. The input device is operative to detect the identification code. The processor is in electric communication with the storage medium and the input device to retrieve the reference information when the input device detects the identification code. The output device is in electric communication with the processor and controlled by the processor to output the reference information.

### BACKGROUND OF THE INVENTION

The present invention relates to a printed matter with multi-medium function and a method of fabricating the same, and more particular, to a printed matter in which texts and/or graphics and identification codes for identifying reference information of the texts and/or graphics.

The conventional book or publication presents contents in the forms of texts and/or graphics, such that some of the contents are often abridged and difficult to understand. References or interpretations of the abridged contents are thus required for the reader to fully comprehend. Compared to the conventional publication which provides single visual effect, the electronic publication which utilizes video, audio, sound and optical effects of a computer provides much more versatile contents to the reader. However, the electronic publication can only be read by a motor or a display. The location for reading the electronic publication is very limited.

### BRIEF SUMMARY OF THE INVENTION

The present invention provides a printed matter with multi-medium functions and a method of implementing the multi-medium functions of the printed matter.

The present invention printed matter includes a plurality of texts and/or graphs and at least one identification code printed on a stationary medium, wherein the identification code for identifying reference information of the texts and/or graphs. The printed matter further comprises a storage medium, an input device, a processor and an output device. The reference information is stored in the storage medium. The input device is operative to detect the identification code. The processor is in electric communication with the storage medium and the input device to retrieve the reference information when the input device detects the identification code. The output device is in electric communication with the processor and controlled by the processor to output the reference information. The storage medium includes a hard disk, a floppy disk, a CD or a DVD. Alternatively, the storage medium may include a remote server. The processor includes a central processing unit of a computer. The input device includes an optical pen, and the output device includes a display screen speaker or an ear phone. The stationary medium includes a book, a magazine, a newspaper, a commercial flyer or a piece of paper.

The method of implementing multi-medium function from a printed matter includes the following steps. A stationary medium such as a book, a magazine, a newspaper, a commercial flyer or a piece of paper is provided. A plurality of texts and/or graphics is printed on the stationary medium. At least one identification code identifying reference information of at least a portion of the text and/or graphics is printed on the stationary medium. The reference information is stored into a storage medium. To access the reference information, the identification code is scanned, and the reference information is retrieved once the identification code is scanned. The step of printing the identification code further comprises printing the identification code next to the portion of the text and/or graphics.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 shows the operation status of a printed matter according to the present invention; and

FIG. 2 shows another operation status of a printed matter according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

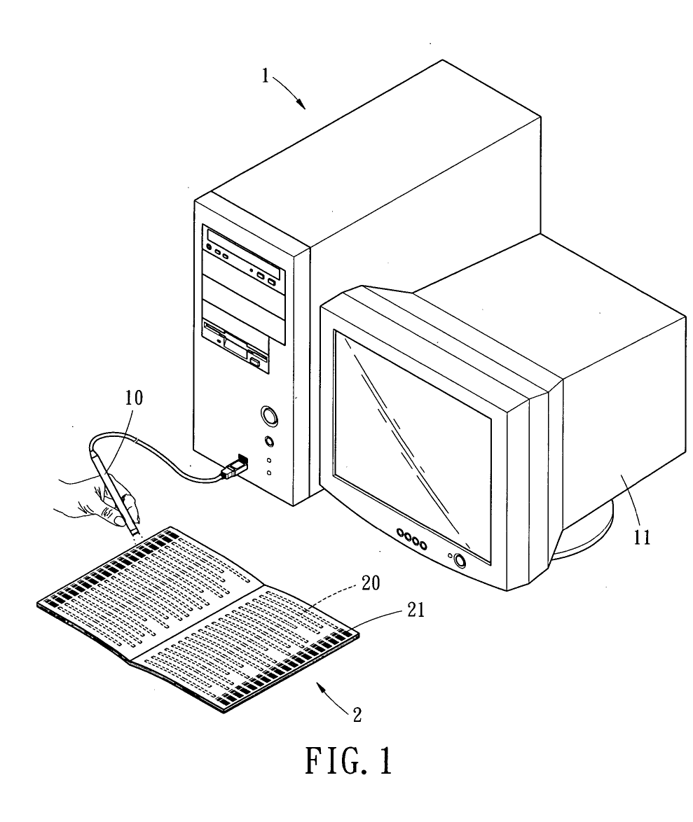

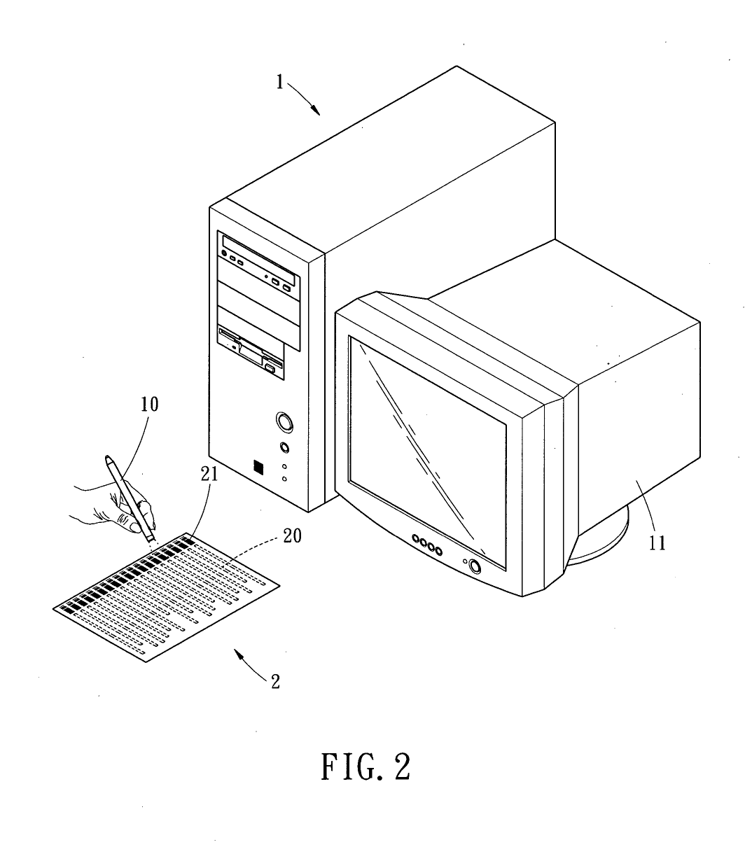

FIGS. 1 and 2 illustrate the operation statuses of a printed matter in a first embodiment and a second embodiment of the present invention. As shown, the printed matter 2 is used together with .an input device 10 and an output device 11 of a computer 1.

The printed matter 2 includes a general book, magazine, newspaper, or other paper-form medium in which texts and graphics can be printed on a single plane. In this embodiment, the printed matter 2 includes a book of a plurality pages on which texts are printed.

To allow the user or reader to access more information while reading the texts printed in the printed matter 2, the information can be stored in a storage device such as a hard disk, a floppy disk, a CD or DVD of the computer. Or alternatively, the information may be retrieved from a network connected with the computer. Therefore, more information can be obtained from a remote server. Therefore, the printed matter 2 with multi-medium function provided by the present invention can also be constructed by incorporating a remote server as well.

Preferably, the information stored in the storage device or the remote server includes interpretation, detailed description or related literatures of the texts 20 printed in the book 2. The information is digitized, followed by presentation by audio, video, sound and light effects of the computer 1. To link or interconnect the texts 20 and the information, identification codes 21 are printed on each page or the selected pages of the book 2. The identification codes 21 can be printed in various forms such as a bar code readable by the input device 10 of the computer 1. Once the input device 10 detects and inputs the identification codes 21 in the computer 1, the information represented by the identification codes 21 is retrieved by the computer 1 and displayed by the output device 11. Therefore, the reader is not only able to read the texts 20 printed on the book 2, but is also to access information related to the texts 20 from the output device 11 of the computer.

For example, if the printed matter 1 includes a book describing the life and merits of a musician. The life, experience and merits of the musician can be presented by texts or graphics printed on the book. When the texts mention certain article or music composed by the musician, such article or music can be encoded in the identification code 21. By inputting the identification code into a computer, such article or music can be automatically displayed by the output device of the computer. The reader can obtain a further knowledge or enjoy the work of the musician.

The input device 10 of the computer includes an optical pen connected to the computer by hard wire as shown in FIG. 1 or wireless transceivers as shown in FIG. 2. Further, the output device 11 includes the screen as shown in FIGS. 1 and 2 and other devices such as speaker. The computer 1 includes personal data assistant (PDA), desktop computer or laptop computer, for example.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A printed matter with multi-medium function, comprising a plurality of texts and/or graphs and at least one identification code printed on a stationary medium, wherein the identification code for identifying reference information of the texts and/or graphs.

2. The printed matter of claim 1, further comprising:
a storage medium for storing the reference information;
an input device in electric communication with the storage medium, the input device being operative to detects the identification code;
a processor, in electric communication with the storage medium and the input device, the processor being operative to retrieve the reference information when the input device detects the identification code; and
an output device in electric communication with the processor, the output device being controlled by the processor to output the reference information.

3. The printed matter of claim 2, wherein the storage medium includes a hard disk, a floppy disk, a CD or a DVD.

4. The printed matter of claim 2, wherein the storage medium includes a remote server.

5. The printed matter of claim 2, wherein the processor includes a central processing unit of a computer.

6. The printed matter of claim 2, wherein the input device includes an optical pen.

7. The printed matter of claim 2, wherein the output device includes a display screen.

8. The printed matter of claim 2, wherein the output device includes a speaker or an ear phone.

9. The printed matter of claim 1, wherein the stationary medium includes a book, a magazine, a newspaper, a commercial flyer or a piece of paper.

10. A method of implementing multi-medium function from a printed matter, comprising:
providing a stationary medium;
printing a plurality of texts and/or graphics on the stationary medium;
printing at least one identification code on the stationary medium, wherein the identification code identifying reference information of at least a portion of the text and/or graphics;
storing the reference information into a storage medium;
scanning the identification code; and
retrieving the reference information.

11. The method of claim 10, wherein the step of providing a stationary medium further comprising providing a book, a magazine, a commercial advertisement, or a newspaper.

12. The method of claim 10, wherein the step of printing the identification code further comprises printing the identification code next to the portion of the text and/or graphics.

13. The method of claim 10, wherein the step of storing the reference information further comprises storing the reference information in a hard disk, a floppy disk, a CD, a DVD, a memory or a remote server.

14. The method of claim 10, wherein the step of scanning the identification code further comprises scanning the identification code by an optical pen.

15. The method of claim 10, wherein the step of retrieving the reference information further comprises retrieving the reference information by a display screen.

16. The method of claim 10, wherein the step of retrieving the reference information further comprises retrieving the reference by a speaker or an ear piece.
